(19) United States
(12) Patent Application Publication
(10) Pub. No.: US 2022/0366512 A1
(43) Pub. Date: Nov. 17, 2022

(54) COMPUTERIZED PAYROLL SYSTEM

(71) Applicant: Gig Forces, Inc. DBA onDiem, Portland, OR (US)

(72) Inventors: Joe Fogg, Portland, OR (US); Beth Deutsche, Santa Rosa, CA (US); Sam Lee, Portland, OR (US)

(21) Appl. No.: 17/662,995

(22) Filed: May 11, 2022

Related U.S. Application Data
(60) Provisional application No. 63/187,872, filed on May 12, 2021.

(51) Int. Cl. G06Q 40/00; G06Q 40/02; G06Q 20/10; G06Q 10/10

(52) U.S. Cl. CPC G06Q 40/125; G06Q 40/02; G06Q 20/102; G06Q 10/1057

(57) ABSTRACT

A computerized payroll system is provided that includes a server having a processor configured to receive from an employee device or from a manager device, a record indicating a total number of hours worked by an employee during a pay period on shifts at different pay rates. The processor is further configured to determine an average pay rate for the total number of hours and any applicable overtime pay rate. The processor is further configured to calculate a benefit amount for the employee. The processor is further configured to display the calculated benefit, display a selector to redeem the calculated benefit, and receive user input via the selector of a request to redeem a requested portion of the calculated benefit, and responsive to receiving the request, initiate a redemption transaction to transfer the requested portion of the calculated benefit to an account identified by the user.

### CROSS REFERENCE TO RELATED APPLICATIONS

This application claims priority to U.S. Provisional Patent Application Ser. No. 63/187,872, filed May 12, 2021 and titled COMPUTERIZED PAYROLL SYSTEM, the entirety of which is hereby incorporated herein by reference for all purposes.

### BACKGROUND

Many workers receive benefits such as paid time off (PTO), health insurance, parental leave, sick leave, and retirement plan contributions from their employers. When workers are employed regularly with a single employer over many years, these benefits are easily calculated and provided for the workers. However, in recent years it has become more common for workers to work at various job locations, for multiple employers, and for irregular time periods. Therefore a challenge exists in providing a technical solution to address these complexities.

### SUMMARY

A computerized payroll system is provided. The computerized payroll system comprises a server including a processor and associated memory. The processor is configured to executed instructions using the memory to receive, from an employee device via an employee graphical user interface or from a manager device via a manager graphical user interface, a record indicating a total number of hours worked by an employee during a pay period. The total number of hours includes at least a first set of hours and a second set of hours. The processor is further configured to determine a first regular pay rate for a first set of hours worked by an employee at a first shift, and to determine a second regular pay rate for a second set of hours worked by the employee at a second shift. The processor is further configured to determine applicable overtime pay rates for the first set or second set of hours, determine an average pay rate for the total number of hours based on the first regular pay rate, the second regular pay rate, and the applicable overtime pay rate. The processor is further configured to calculate a benefit amount for a benefit type for the employee based on the number of hours worked by the employee and average rate of pay of the employee during the pay period. The processor is further configured to, via the employee graphical user interface, display the calculated benefit, display a selector to redeem the calculated benefit, and receive user input via the selector of a request to redeem a requested portion of the calculated benefit. Responsive to receiving the request, the processor is further configured to initiate a redemption transaction to transfer the requested portion of the calculated benefit to an account identified by the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computerized payroll system.

FIG. 2 is an example manager work calendar implemented by the computerized payroll system of FIG. 1.

FIG. 3 illustrates a new temporary job post feature implemented by a manager device of the computerized payroll system of FIG. 1.

FIG. 4 is an example employee work calendar implemented by the computerized payroll system of FIG. 1.

FIG. 5 illustrates a position summary displayed on an employee device of the computerized payroll system of FIG. 1.

FIG. 6 illustrates a timesheet confirmation generated by the computerized payroll system of FIG. 1 and displayed on the employee device.

FIG. 7A illustrates a paid time off request processed by the computerized payroll system of FIG. 1 and displayed on the employee device.

FIG. 7B illustrates an example paid time off details box generated by the computerized payroll system of FIG. 1.

FIGS. 8A and 8B show a flowchart for a computerized payroll method.

FIG. 9 is an example computing system according to an embodiment of the present description.

### DETAILED DESCRIPTION

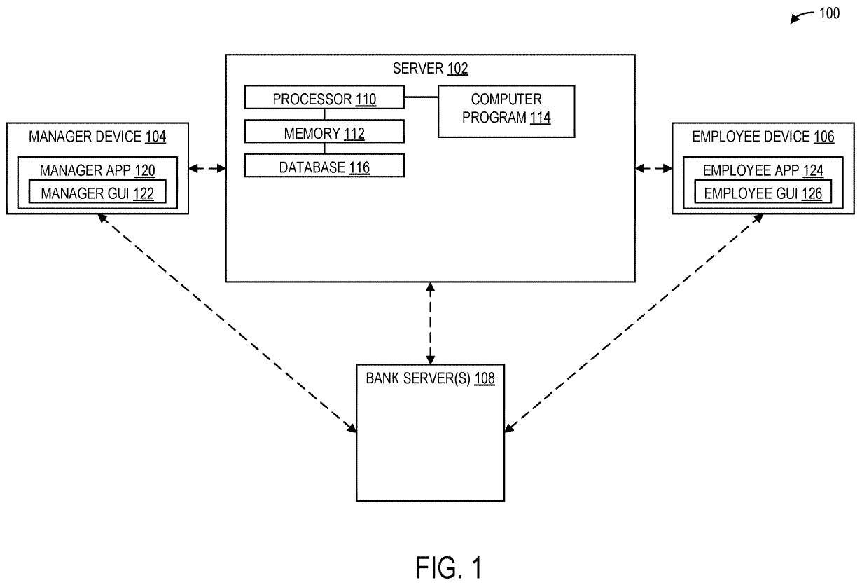

To address the issues discussed above, as shown in FIG. 1, a computerized payroll system is provided 100. The computerized payroll system 100 includes a server 102 in communication with a manager device 104, an employee device 106, and at least one server belonging to a financial institution, e.g., bank servers 108. The server 102 includes a processor 110 and associated memory 112. The processor 110 is configured to executed instructions included in a computer program 114 using the memory 112. The server 102 further includes a database 116 storing employee information including employee profiles. The computerized payroll system 100 includes a manager application 120 including a manager graphical user interface (GUI) 122 that is executable on the manager device 104. The computerized payroll system 100 further includes an employee application 124 including an employee graphical user interface (GUI) 126 that is executable on the employee device 106. Features of the computerized payroll system 100 allow a manager and employee to easily schedule works shifts and manage compensation and benefits in a complex work environment including multiple work sites, rates of pay, and employees having diverse availabilities and attributes. A detailed description of the computerized payroll system 100 follows.

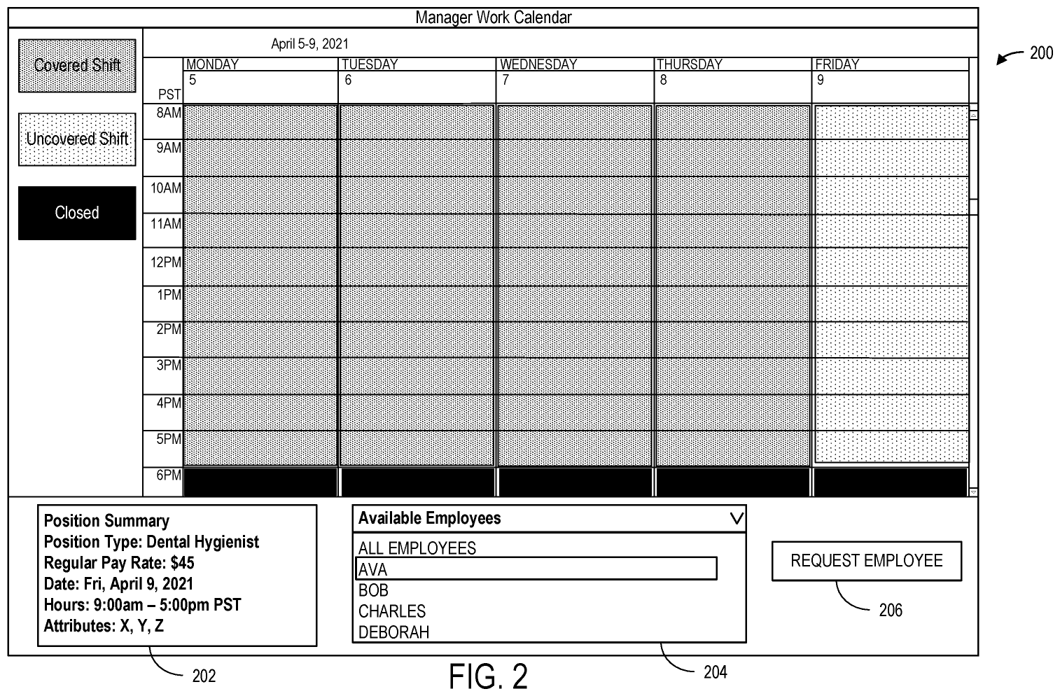

Turning now to FIG. 2, an example of a manager work calendar 200 for a dental practice is shown for the work week of April 5-9. While a dental practice is used in this example, it will be appreciated that the computerized payroll system 100 may be implemented in any type of business having more than one employee. The manager work calendar 200 is maintained by the processor 110 and displayed at the manager device 104 via the manager GUI 122. The manager work calendar 200 includes shifts during which employees are needed (i.e., uncovered shifts), covered shifts, and times when the dental practice is closed. In this example, shifts on Monday through Thursday are covered; however, a dental hygienist is needed to work a shift from 9 am to 5 pm on Friday. When the uncovered shift on Friday is selected, a position summary 202 is displayed on the manager work calendar 200. The position summary 202 includes several fields including the position type (dental hygienist), an offered pay rate of $45/hour, date of the uncovered shift, hours for the uncovered shift, and employee attributes required for filling the shift. The computerized payroll system 100 is configured such that the manager work calendar 200 is editable via the manager device 104. For example, new shifts can be added, existing shifts can be deleted, employee attributes can be modified, and all other fields of the position summary 202 are editable. Furthermore, the manager work calendar 200 is enabled to display uncovered shifts for more than one employee and more than one position. However, for clarity, only one uncovered shift is shown in the example illustrated in FIG. 2.

An available employee list 204 shows a list of employees who are available to work the uncovered shift. The available employee list 204 displays employees having availability during the shift and the required employee attributes. To populate the list of employees, the computerized payroll system 100 references the database 116, which includes a plurality of employee profiles maintained by the processor 110. Each employee profile includes the following employee attributes: work skills of the employee, a duration of work experience of the employee, a geographic location of the employee, contact information of the employee, the regular pay rate of the employee, availability of the employee, educational credentials of the employee, and certifications of the employee. The database 116 is configurable such that employee attributes may be added or deleted. While the database 116 may include hundreds or even thousands of employee profiles, it will be appreciated that only employees having the required employee attributes are shown in the available employee list 204.

The manager work calendar 200 further includes a selectable “request employee” selector 206. As used herein the term selector refers to a graphical user input component configured to receive user input to select an option presented to the user, specific examples of which are a button, a drop-down menu with single or multiple selectable options, slider, hyperlink, a checkbox, etc. When at least one employee on the available employee list 204 and the “request employee” selector 206 are selected, the server 102 receives, from the manager device 104, the selection of the at least one employee requested to work the shift. Responsive to receiving the selection from the manager device 104, the server 102 sends a notification to the employee device 106, indicating that the employee has been selected to fill the shift. In the example shown in FIG. 2, Ava has been selected; therefore, Ava's employee device 106 receives the notification. However, any other available employee, combination of employees, or all employees can be selected to receive the notification. In one configuration, Ava is automatically assigned to work the shift; however, in another configuration, Ava must confirm that she will work during the shift.

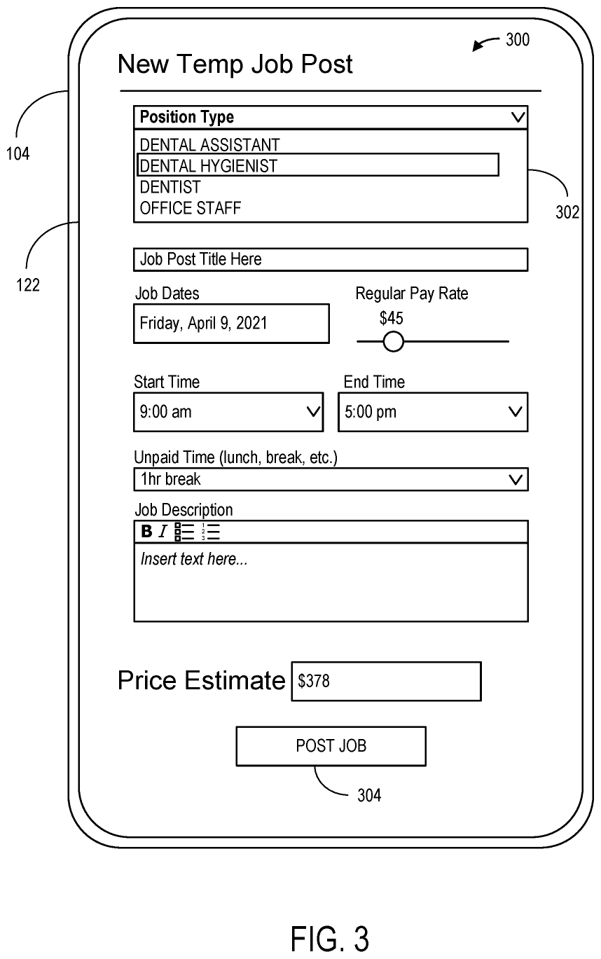

FIG. 3 shows a new temporary job post feature 300 displayed in the manager GUI 122, which is accessed via the manager application 120 on the manager device 104. This feature can be used to create a shift, such as the uncovered shift of FIG. 2. The new temporary job post feature 300 includes several fields such as a position type menu 302 that lists selectable position types that are available at the dental practice. Other fields include a job post title field, job date, regular pay rate, start time, end time, unpaid time, and job description field. All fields are editable and can be saved collectively for future job posts. In the example of FIG. 3, a shift of seven paid hours at $45/hour for a dental hygienist has a price estimate of $378. The price estimate includes $315 for hours worked plus a percentage (20% in this example) to accommodate additional costs such as overhead, benefits, etc. as will be described in detail below. When all applicable fields have been filled as needed for the uncovered shift, the new temporary job post feature 300 may be sent to the server 102 by selecting a “post job” selector 304, which enables information for the temporary job be transmitted to one or more employee devices 106 and displayed as an available shift in the employee work calendar 400, as described in detail below.

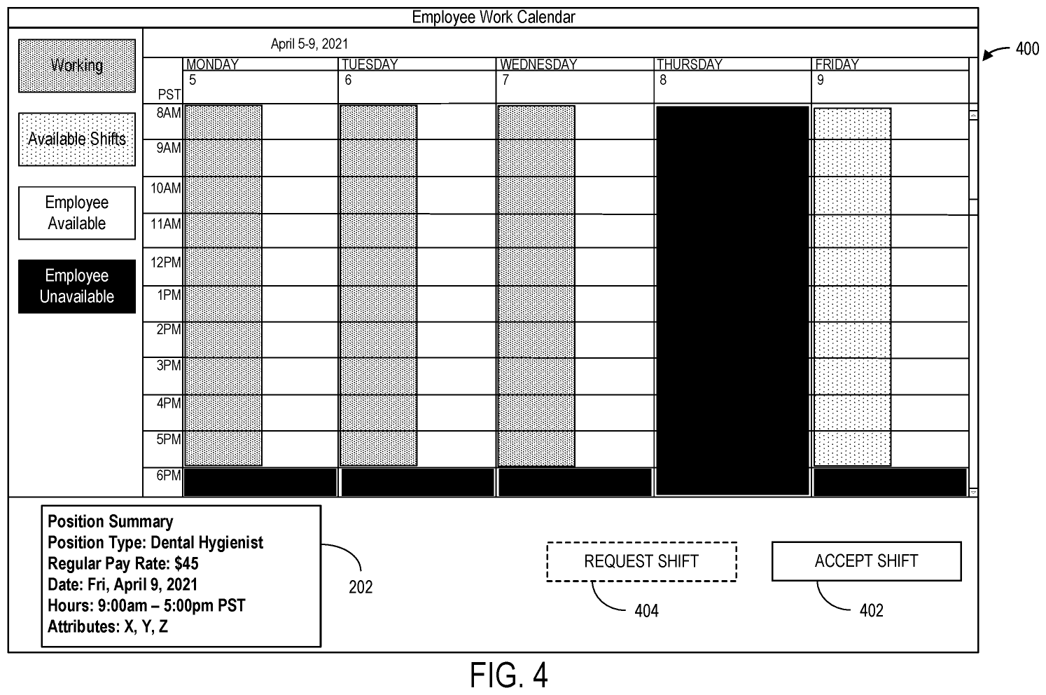

FIG. 4 shows an employee work calendar 400 of the computerized payroll system 100. Similarly to the manager work calendar 200, the employee work calendar 400 is maintained by the processor 110 and displayed at the employee device 106 via the employee GUI 126. The employee work calendar 400 includes available shifts for which the employee fulfills the required attributes. The employee work calendar 400 includes time periods during which the employee is available to work. The time periods are selectable by the employee and displayable on the manager device 104. The employee work calendar 400 also includes shifts during which the employee is scheduled to work. In the illustrated example, the employee is available to work Monday, Tuesday, Wednesday, and Friday; unavailable Thursday and every day after 5 pm; and scheduled to work Monday, Tuesday, and Wednesday. As shown, there is an available shift on Friday, from 9 am to 5 pm that was scheduled via the manager device 104. When the available shift is selected on the employee work calendar 400, the position summary 202 is displayed. In this example, the employee can confirm they will work the available shift via a selectable “accept shift” selector 402. Once the employee accepts the available shift, the available shift is confirmed and scheduled for the employee. The computerized payroll system 100 receives the selection from the employee via the employee device to accept work during the available shift, and, responsive to receiving the selection, sends a notification to the manager via the manager device that the employee has accepted work during the available shift. In embodiments in which the employee is not scheduled for an available shift via the manager device 104, the employee via the employee device may send a request to be scheduled for the posted available shift by selecting a “request shift” selector 404, as indicated by the dashed line in FIG. 4.

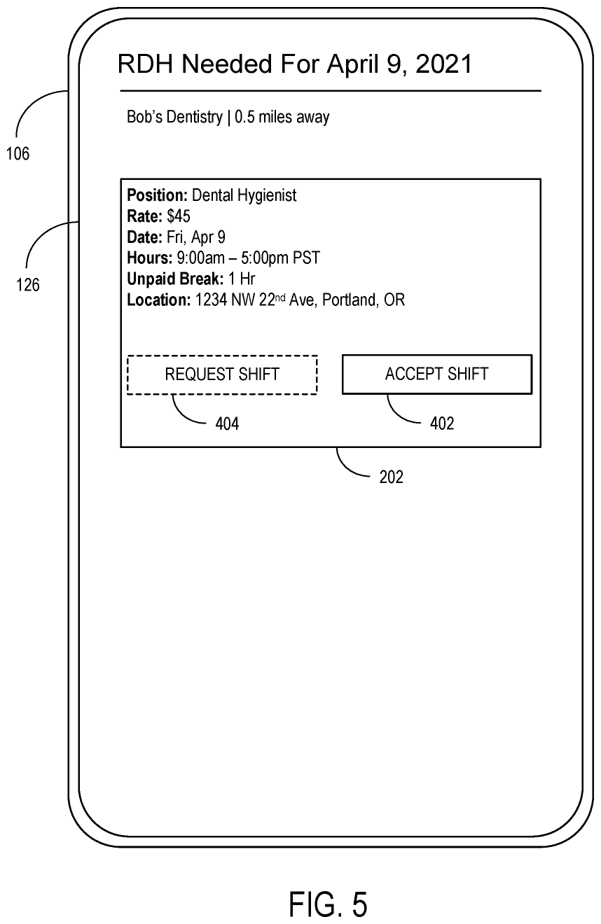

In the example illustrated in FIG. 4, the available shift is displayed on the employee work calendar 400 accessed by the employee device 106. Additionally or alternatively, as shown in FIG. 5, the computerized payroll system 100 may be configured to send a push notification to the employee device 106 when the available shift is created. When the push notification is selected, the position summary 202 is displayed in the employee GUI 126. As with the embodiment described above for the employee work calendar, the employee can accept an available shift that has been scheduled for them via the manager device 104 by selecting an “accept shift” selector, or request to be scheduled for an available shift by selecting a “request shift” selector.

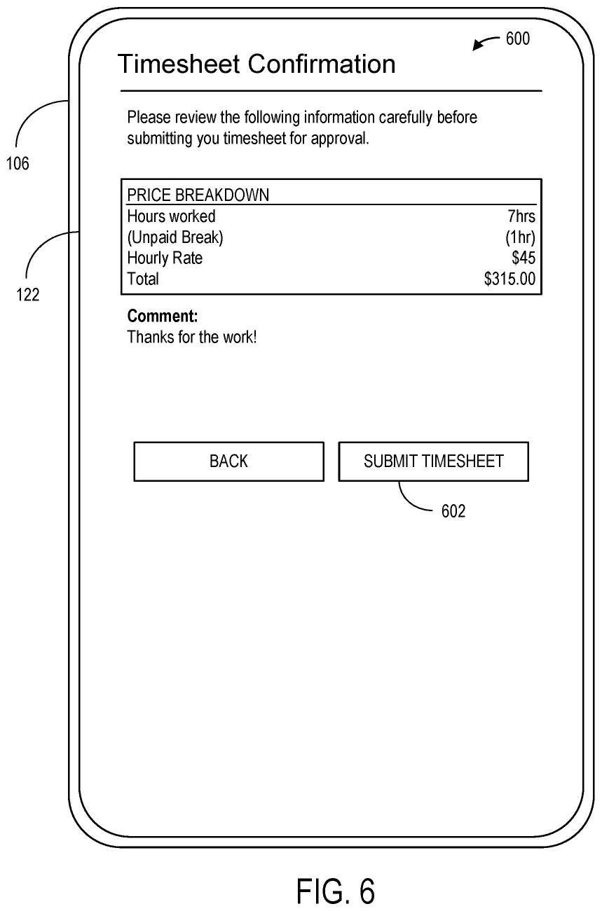

At the conclusion of a worked shift, the computerized payroll system 100 is configured to send a timesheet confirmation 600 to the employee device 106, as shown in FIG. 6. The timesheet confirmation 600 includes fields for hours worked, unpaid break, hourly rate, and total money earned for the worked shift. The fields are consistent with those in the position summary 202; however, the fields in the timesheet confirmation 600 are editable to accommodate any changes that may have occurred such as a shortened break, or a change in start time or end time of the shift. When the employee confirms that the information in the timesheet confirmation 600 is correct, the employee may select a “submit timesheet” selector 602, causing the timesheet to be transmitted to and stored in the database 116 of the server 102. In one example, the server 102 is configured to initiate a transaction with a bank server 108 to deposit funds into an account of the employee.

In addition to regular pay, the computerized payroll system 100 calculates overtime pay, i.e., pay that is earned at a pay rate that is a predetermined percentage higher than the regular pay rate. Generally, overtime pay is earned during hours worked beyond a regular number of hours in a particular time period. For example, overtime pay may be earned after the worker has worked eight hours in a day, or after 40 hours in a week, although other time periods may be used. Additionally, the computerized payroll system 100 is configured to calculate paid time off (PTO). Generally, PTO is accrued by the employee as a percentage of time worked. For example, the employee may work 100 hours at a 5% PTO accrual rate. After working the 100 hours, the employee has earned five hours of total PTO, the value of which is five times the hourly pay rate at which the 100 hours were worked.

While the above example of calculating PTO is relatively simple, calculating benefits such as PTO can be much more complicated in situations in which employees work at different work sites, at different regular pay rates, under different benefit policies, etc. To accommodate these situations, the processor 110 is configured to receive, from the employee device 106 via the employee graphical user interface 126 or from the manager device 104 via the manager graphical user interface 122, a record indicating a total number of hours worked by an employee during a pay period, including at least a first set of hours and a second set of hours. The pay period may be a full pay period (e.g., a 40-hour week) or a partial pay period. The partial pay period may be selectable by the employee via the employee device 106 or the manager via the manager device 104. The processor 110 is further configured to determine a first regular pay rate for the first set of hours worked by the employee at a first shift and a second regular pay rate for the second set of hours worked by the employee at a second shift. Applicable overtime pay rates for the first and/or second set of hours are determined, as well as an average pay rate for the total number of hours based on the first regular pay rate, the second regular pay rate, and the applicable overtime pay rate. Based on the number of hours worked by the employee and average rate of pay of the employee during the pay period, the processor 110 calculates a benefit amount for a benefit type for the employee. While the benefit type in this example is PTO, it will be appreciated that the processor 110 may be configured to calculate benefit amounts for other benefit types such as credit card points, funds applied to retirement or investment accounts, shares of stock, and the like.

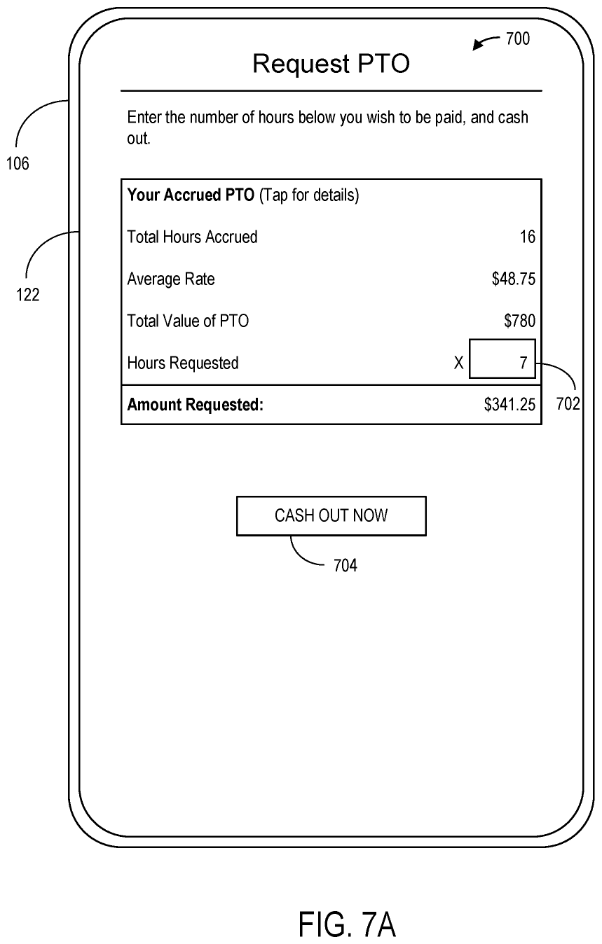

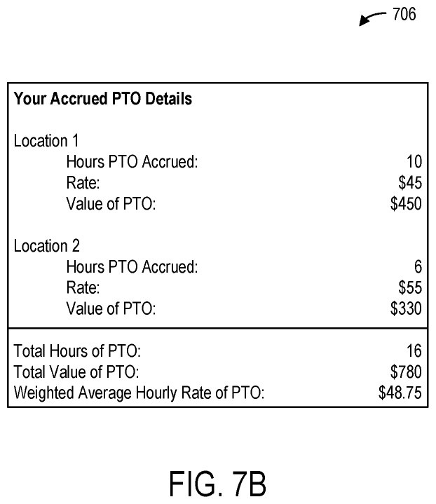

FIG. 7A shows a PTO request 700 displayed on the employee device 106. The PTO request 700 is displayed to the employee via the employee graphical user interface 126 and includes the calculated benefit and a selector 702. The employee may submit a request to redeem all or a portion of the calculated benefit by entering the number of hours desired for the PTO request via the selector 702. The request may be initiated by selecting a “cash out now” selector 704, which transmits the request to the processor 110. Responsive to receiving the request, the processor 110 is configured to initiate a redemption transaction to transfer the requested portion of the calculated benefit to an account identified by the user. In the illustrated example, the benefit type is paid time off, and the redemption transaction is a monetary transfer of funds in the amount of the requested portion of the calculated benefit to the account of the employee. As shown, the calculated benefit is 16 hours of PTO valued at $780, and the requested portion of the calculated benefit is seven hours at a weighted average rate of $48.75/hour for a total of $341.25. This configuration is beneficial because it permits the employee to receive benefits such as PTO whenever the employee desires.

The employee may view the employee's accrued PTO by inputting a selection to open a paid time off details window 706, as illustrated in FIG. 7B. The paid time off details window 706 is displayed on the employee device 106 via the employee graphical user interface 126, as illustrated in FIG. 7B. The paid time off details box 706 shows details of PTO accrued for each location at which the employee has worked. In this example, at Location 1, the employee has accrued 10 hours of PTO at a rate of $45/hour for a total of $450. At Location 2, the employee has accrued six hours of PTO at a rate of $55/hour for a total of $330. Based on the PTO accrued at Locations 1 and 2, the employee has accrued a total of 16 hours of PTO at an average rate of $48.75/hour for a total value of $780. The average rate, therefore, is a weighted average rate based upon the hours accrued and rates for each location. It will be appreciated that the values shown in FIG. 7B are exemplary, and that the computerized payroll system 100 accommodates three, four, or any other number of locations and PTO rates in calculating the total hours of PTO, total value of PTO, and average rate of PTO.

In addition to the above features which allow for managers and employees to easily find shifts, keep timesheets, handle paychecks, PTO, and other benefits, the computerized payroll system 100 is configured to perform record keeping functions to benefit both managers and employees. For example, processor 110 is further configured to maintain a manager work history accessible by the manager device 104. The manager work history includes fulfilled shifts, unfulfilled shifts, shifts worked by each employee, pay rates for each fulfilled shift, pay rates for each unfulfilled shift, calculated benefits available to each employee, and calculated benefits redeemed by each employee. The manager work history is configured to be customizable so that other information can also be stored in the manager work history.

Additionally, the computerized payroll system 100 maintains records for each employee. For example, the processor 110 is further configured to maintain an employee work history accessible by the employee device 106. The employee work history includes shifts worked by the employee, a list of offers to work and associated pay rates received by the employee, calculated benefits available to the employee, and calculated benefits redeemed by the employee. The employee work history is configured to be customizable so that other information can also be stored in the employee work history.

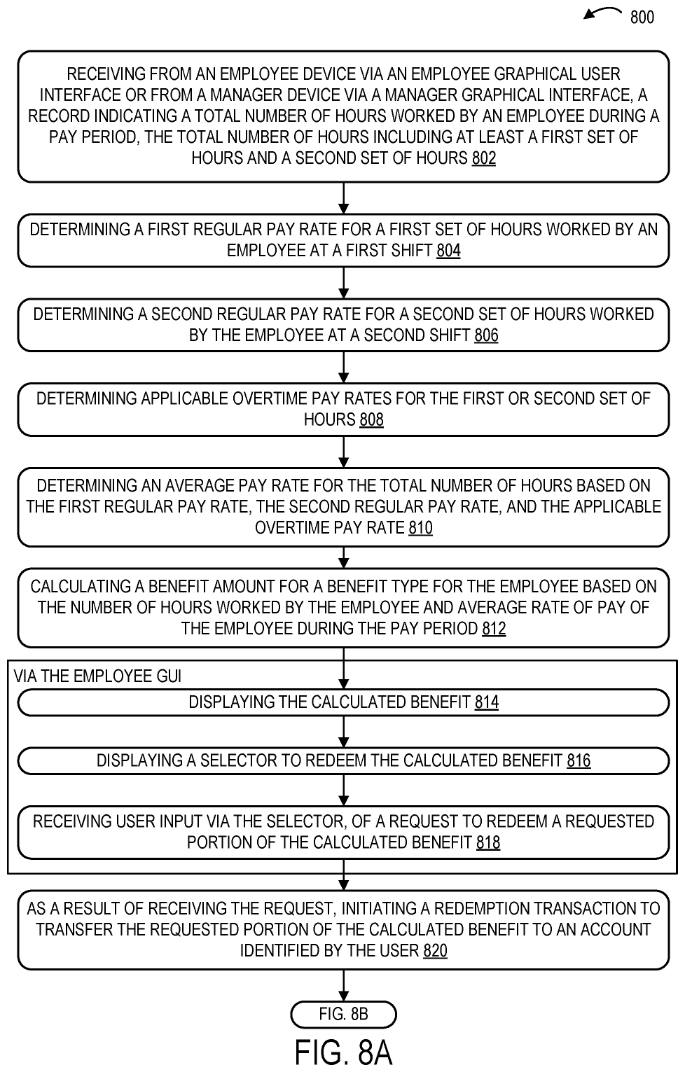

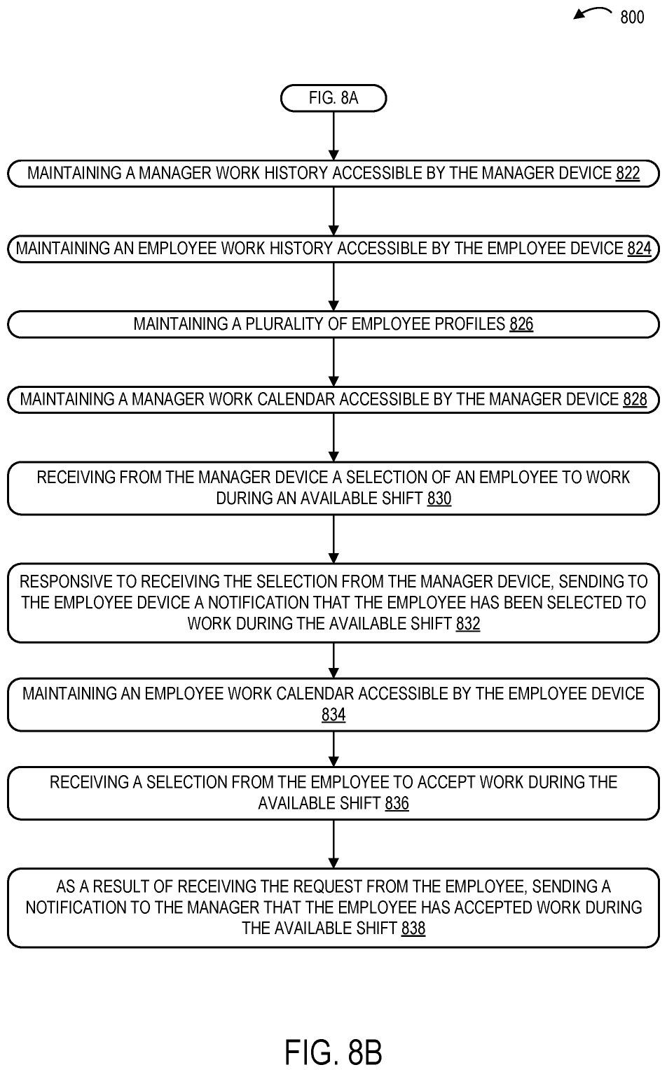

Turning to FIGS. 8A, and 8B, a computerized payroll method 800 will now be described. It will be appreciated that the method 800 may be implemented using the above described computerized payroll system 100 or other suitable hardware and software componentry. The method 800 may be used with a server including a processor and associated memory, the processor is configured to executed instructions using the memory. At step 802, the method 800 comprises receiving from an employee device via an employee graphical user interface or from a manager device via a manager graphical user interface, a record indicating a total number of hours worked by an employee during a pay period, the total number of hours including at least a first set of hours and a second set of hours. At step 804, the method 800 further comprises determining a first regular pay rate for a first set of hours worked by an employee at a first shift. At step 806, the method 800 further comprises determining a second regular pay rate for a second set of hours worked by the employee at a second shift. At step 808, the method 800 further comprises determining applicable overtime pay rates for the first or second set of hours. At step 810, the method 800 further comprises determining an average pay rate for the total number of hours based on the first regular pay rate, the second regular pay rate, and the applicable overtime pay rate. At step 812, the method 800 further comprises calculating a benefit amount for a benefit type for the employee based on the number of hours worked by the employee and average rate of pay of the employee during the pay period. Steps 814, 816, and 818 may be performed via the employee graphical user interface. At step 814, the method 800 further comprises displaying the calculated benefit. At step 816, the method 800 further comprises displaying a selector to redeem the calculated benefit. At step 818, the method 800 further comprises receiving user input via the selector, of a request to redeem a requested portion of the calculated benefit. At step 820, the method 800 further comprises, as a result of receiving the request, initiating a redemption transaction to transfer the requested portion of the calculated benefit to an account identified by the user. The benefit type may be paid time off, and the redemption transaction may be a monetary transfer of funds in the amount of the requested portion of the calculated benefit, to the account of the employee.

At step 822, the method 800 further comprises maintaining a manager work history accessible by the manager device. The manager work history may include fulfilled shifts, unfulfilled shifts, shifts worked by each employee, pay rates for each fulfilled shift, pay rates for each unfulfilled shift, calculated benefits available to each employee, and calculated benefits redeemed by each employee. At step 824, the method 800 further comprises maintaining an employee work history accessible by the employee device. The employee work history may include shifts worked by the employee, a list of offers to work and associated pay rates received by the employee, calculated benefits available to the employee, and calculated benefits redeemed by the employee.

At step 826, the method 800 further comprises maintaining a plurality of employee profiles. Each employee profile may include the following employee attributes: work skills of the employee, a duration of work experience of the employee, a geographic location of the employee, contact information of the employee, the regular pay rate of the employee, availability of the employee, educational credentials of the employee, and certifications of the employee. At step 828, the method 800 further comprises maintaining a manager work calendar accessible by the manager device. The manager work calendar may include shifts during which employees are needed, required attributes of the needed employees, an offered pay rate, and a list of employees available during the shifts in which employees are needed, the list of employees comprising employees having availability during the shift and the required attributes. At step 830, the method 800 further comprises receiving from the manager device a selection of at least one employee to work during a shift. At step 832, the method 800 further comprises, as a result of receiving a selection from the manager device, sending to the employee device a notification that the employee has been selected to work during the shift. The manager work calendar may be editable via the manager device such that new shifts are addable, existing shifts are deletable, and employee attributes are changeable. At step 834, the method 800 further comprises maintaining an employee work calendar accessible by the employee device. The employee work calendar may include available shifts for which the employee has required attributes, time periods during which the employee is available to work, the time periods being selectable by the employee and displayable on the manager device, and shifts during which the employee is scheduled to work. At step 836, the method 800 further comprises receiving a request from the employee via the employee device to accept work during one of the available shifts. At step 838, the method 800 further comprises, as a result of receiving the request from the employee, sending a notification to the manager via the manager device that the employee has accepted work during one of the available shifts.

In some embodiments, the methods and processes described herein may be tied to a computing system of one or more computing devices. In particular, such methods and processes may be implemented as a computer-application program or service, an application-programming interface (API), a library, and/or other computer-program product.

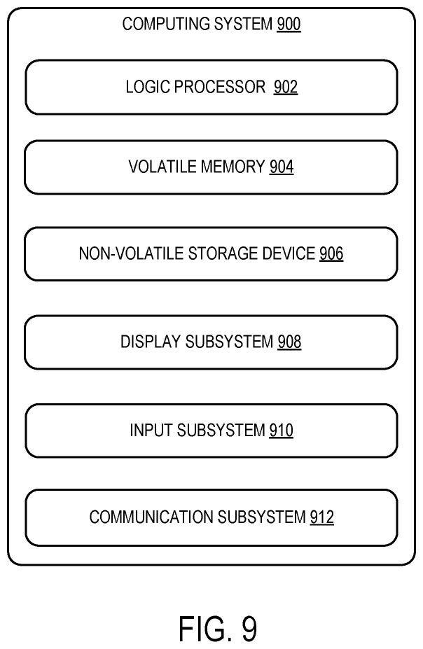

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 904, and a non-volatile storage device 906. Computing system 900 may optionally include a display subsystem 908, input subsystem 910, communication subsystem 912, and/or other components not shown in FIG. 9.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the logic processors to implement the methods and processes described herein. When such methods and processes are implemented, the state of non-volatile storage device 906 may be transformed—e.g., to hold different data.

Non-volatile storage device 906 may include physical devices that are removable and/or built-in. Non-volatile storage device 906 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by logic processor 902 to temporarily store information during processing of software instructions. It will be appreciated that volatile memory 904 typically does not continue to store instructions when power is cut to the volatile memory 904.

Aspects of logic processor 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with logic processor 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet.

1. A computerized payroll system comprising:
a server including a processor and associated memory, the processor configured to executed instructions using the memory to:
receive, from an employee device via an employee graphical user interface or from a manager device via a manager graphical user interface, a record indicating a total number of hours worked by an employee during a pay period, the total number of hours including at least a first set of hours and a second set of hours;
determine a first regular pay rate for the first set of hours worked by an employee at a first shift;
determine a second regular pay rate for the second set of hours worked by the employee at a second shift;
determine applicable overtime pay rates for the first set and/or second set of hours;
determine an average pay rate for the total number of hours based on the first regular pay rate, the second regular pay rate, and the applicable overtime pay rate;
calculate a benefit amount for a benefit type for the employee based on the number of hours worked by the employee and the average rate of pay of the employee during the pay period;
via the employee graphical user interface, display the calculated benefit, display a selector to redeem the calculated benefit, and receive user input via the selector, of a request to redeem a requested portion of the calculated benefit; and
responsive to receiving the request, initiate a redemption transaction to transfer the requested portion of the calculated benefit to an account identified by the user.

2. The computerized payroll system of claim 1, wherein
the benefit type is paid time off, and
the redemption transaction is a monetary transfer of funds in the amount of the requested portion of the calculated benefit to the account of the employee.

3. The computerized payroll system of claim 1, wherein
the processor is further configured to maintain a manager work history accessible by the manager device, and
the manager work history includes at least one of:
fulfilled shifts;
unfulfilled shifts;
shifts worked by each employee;
pay rates for each fulfilled shift;
pay rates for each unfulfilled shift;
calculated benefits available to each employee; and
calculated benefits redeemed by each employee.

4. The computerized payroll system of claim 1, wherein
the processor is further configured to maintain an employee work history accessible by the employee device, and
the employee work history includes at least one of:
shifts worked by the employee;
a list of offers to work and associated pay rates received by the employee;
calculated benefits available to the employee; and
calculated benefits redeemed by the employee.

5. The computerized payroll system of claim 1, wherein the processor is further configured to maintain a plurality of employee profiles, and each employee profile includes at least one of the following employee attributes:
work skills of the employee;
a duration of work experience of the employee;
a geographic location of the employee;
contact information of the employee;
the regular pay rate of the employee;
availability of the employee;
educational credentials of the employee; and
certifications of the employee.

6. The computerized payroll system of claim 5, wherein the processor is further configured to:
maintain a manager work calendar accessible by the manager device, the manager work calendar including at least one of:
a shift for which employees are needed;
required attributes of the needed employees;
an offered pay rate; and
a list of employees available during the shift for which employees are needed, the list of employees comprising employees having availability during the shift and the required attributes,
receive from the manager device a selection of at least one employee to work during the shift, and
responsive to receiving a selection from the manager device, send to the employee device a notification that the employee has been selected to work during the shift.

7. The computerized payroll system of claim 6, wherein
the manager work calendar is editable via the manager device such that:
new shifts are addable;
existing shifts are deletable; and
employee attributes are changeable.

8. The computerized payroll system of claim 5, wherein the processor is further configured to:
maintain an employee work calendar accessible by the employee device, the employee work calendar including at least one of:
an available shift for which the employee has required attributes;
time periods during which the employee is available to work, the time periods being selectable by the employee and displayable on the manager device; and
shifts during which the employee is scheduled to work.

9. The computerized payroll system of claim 8, wherein the processor is further configured to:
send to the employee device a notification that the employee has been selected to work during the available shift,
receive a selection from the employee via the employee device to accept work during the available shift, and
responsive to receiving the selection from the employee, send a notification to the manager via the manager device that the employee has accepted work during one of the available shifts.

10. The computerized payroll system of claim 8, wherein the processor is further configured to:
receive a selection from the employee via the employee device to request to be scheduled to work during the available shift, and
responsive to receiving the selection from the employee, send a notification to the manager via the manager device that the employee has requested to be scheduled to work during the available shift.

11. A method for executing a computerized payroll, the method comprising:
at a processor of a computerized payroll system:
receiving from an employee device via an employee graphical user interface or from a manager device via a manager graphical user interface, a record indicating a total number of hours worked by an employee during a pay period, the total number of hours including at least a first set of hours and a second set of hours;
determining a first regular pay rate for a first set of hours worked by an employee at a first shift;
determining a second regular pay rate for a second set of hours worked by the employee at a second shift;
determining applicable overtime pay rates for the first or second set of hours;
determining an average pay rate for the total number of hours based on the first regular pay rate, the second regular pay rate, and the applicable overtime pay rate;
calculating a benefit amount for a benefit type for the employee based on the number of hours worked by the employee and average rate of pay of the employee during the pay period;
via the employee graphical user interface:
displaying the calculated benefit;
displaying a selector to redeem the calculated benefit;
receiving user input via the selector, of a request to redeem a requested portion of the calculated benefit; and
responsive to receiving the request:
initiating a redemption transaction to transfer the requested portion of the calculated benefit to an account identified by the user.

12. The method of claim 11, wherein
the benefit type is paid time off,
the redemption transaction is a monetary transfer of funds, and
the method further comprises:
transferring the amount of the requested portion of the calculated benefit to the account of the employee.

13. The method of claim 11, further comprising:
maintaining a manager work history accessible by the manager device, the manager work history including at least one of:
fulfilled shifts;
unfulfilled shifts;
shifts worked by each employee;
pay rates for each fulfilled shift;
pay rates for each unfulfilled shift
calculated benefits available to each employee; and
calculated benefits redeemed by each employee.

14. The method of claim 11, further comprising:
maintaining an employee work history accessible by the employee device, the employee work history including at least one of:
shifts worked by the employee;
a list of offers to work and associated pay rates received by the employee;
calculated benefits available to the employee; and
calculated benefits redeemed by the employee.

15. The method of claim 11, further comprising:
maintaining a plurality of employee profiles, each employee profile including at least one of the following employee attributes:
work skills of the employee;
a duration of work experience of the employee;
a geographic location of the employee;
contact information of the employee;
the regular pay rate of the employee;
availability of the employee;
educational credentials of the employee; and
certifications of the employee.

16. The method of claim 15, further comprising:
maintaining a manager work calendar accessible by the manager device, the manager work calendar including at least one of:
shifts during which employees are needed,
required attributes of the needed employees,
an offered pay rate, and
a list of employees available during the shifts in which employees are needed, the list of employees comprising employees having availability during the shift and the required attributes;
receiving from the manager device a selection of at least one employee to work during a shift; and
responsive to receiving a selection from the manager device, sending to the employee device a notification that the employee has been selected to work during the shift.

17. The method of claim 16, further comprising:
configuring the manager work calendar to be editable via the manager device such that:
new shifts are addable;
existing shifts are deletable; and
employee attributes are changeable.

18. The method of claim 15, further comprising:
maintaining an employee work calendar accessible by the employee device, the employee work calendar including at least one of:
available shifts for which the employee has required attributes;
time periods during which the employee is available to work, the time periods being selectable by the employee and displayable on the manager device; and
shifts during which the employee is scheduled to work.

19. The method of claim 18, further comprising:
sending, to the employee device, a notification that the employee has been selected to work during the available shift;
receiving a selection from the employee via the employee device to accept work during the available shift; and
responsive to receiving the selection from the employee, sending a notification to the manager via the manager device that the employee has accepted work during one of the available shifts.

20. The method of claim 18, further comprising:
receiving a selection from the employee via the employee device to request to be scheduled to work during the available shift, and
responsive to receiving the selection from the employee, sending a notification to the manager via the manager device that the employee has requested to be scheduled to work during the available shift.
